(19) United States
(12) Patent Application Publication
(10) Pub. No.: US 2006/0159255 A1
(43) Pub. Date: Jul. 20, 2006

(54) Method for using an auto-dialer to rate contact information entered by visitors to web sites

(76) Inventor: John Sung Kim, Dublin, CA (US)

Correspondence Address: Maad Abu-Ghazalah, P.O. Box 1219, Pacifica, CA, 94044, US

(21) Appl. No.: 11/333,960

(22) Filed: Jan. 17, 2006

Related U.S. Application Data
(60) Provisional application No. 60/644,479, filed on Jan. 18, 2005.

(51) Int. Cl. H04M 1/00

(52) U.S. Cl. 379/357.03

(57) ABSTRACT

A method is presented for using an autodialer to automatically rate contact information obtained through a web site. The autodialer automatically calls the contact numbers and records the type of responses received and rating the contact information accordingly.

We claim priority to: Provisional Application No. 60/644,479 filed on Jan. 18, 2005.

### BACKGROUND OF THE INVENTION

1. Field of the Invention

The present invention relates to an improved data processing system, and, in particular, to a business practice.

2. Description of Related Art

A sales lead is contact information that is used by salespeople to contact potential buyers in order to make a sale. Sales leads are a valuable commodity in business, and salespeople often calculate the value of sales leads by determining the percentage of sales leads that eventually lead to actual sales. The higher the percentage of contacts that lead to a sale, the more valuable the sales leads, since there is a cost associated with each attempt to make a sale and there is usually a profit associated with each actual sale.

One of the main problems with sales leads is that much of the contact information is invalid either because it is outdated, e.g. the contact has moved, or it is simply incorrect, e.g. the contact provided inaccurate information. This reduces the overall value of the sales leads since, obviously, no sale can be generated from a lead that is not valid.

Manually verifying each contact information may be impractical due to time and/or cost restraints. Call centers are sometimes utilized for this purpose to manually call each contact. However, call centers typically require an entire list of phone numbers to be provided at one time, and cannot process phone numbers being provided one at a time. The call centers can also be expensive and time consuming. Therefore, most sales leads are sold with the expectation that at least some of the contact information is probably invalid.

### SUMMARY OF THE INVENTION

A method is presented for using an autodialer to automatically verify and rate contact information entered on a website by calling the contact number and recording the type of responses received and rating the contact information accordingly.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1 is a flow chart depicting the process through which an autodialer automatically verifies and rates contact information obtained through a website.

FIG. 2 is a flow chart depicting the process through which an autodialer rates contact information based on the type of response received.

### DETAILED DESCRIPTION OF THE INVENTION

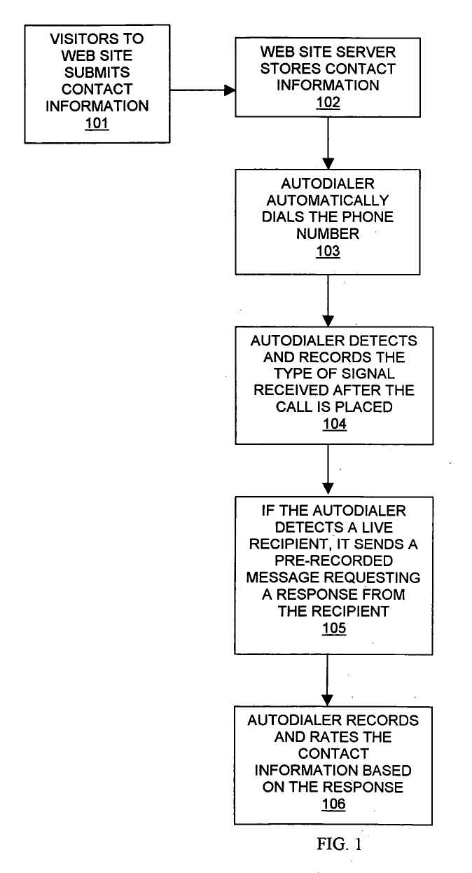

With reference to FIG. 1, a flow chart depicts the process through which an autodialer automatically verifies and rates contact information obtained through a website. The process begins with a visitor to a website submitting their contact information, e.g. phone number and address (step 101). The web site server stores the contact information in a database (step 102). An autodialer then automatically calls the phone numbers in the database (step 103). In one embodiment, the autodialer waits until a thresshold number of contacts have been stored in the database before making the calls. In another embodiment, the autodialer waits until an appropriate time, based on the phone number's area code for example, to make the automatic phone call.

The autodialer detects and records the response from the phone call (step 104). If the autodialer detects a live recipient, it sends a pre-recorded message requesting a response from the recipient. The autodialer then rates the contact information based on the response from the call and stores the rating in the database.

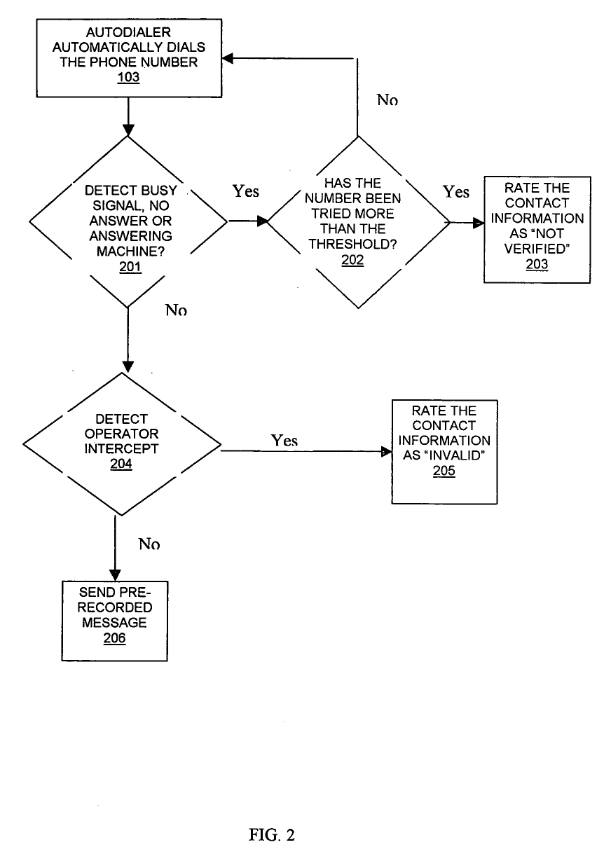

Referring now to FIG. 2, a flow chart depicts the process through which an autodialer rates contact information based on the type of response received. After the autodialer automatically calls the phone number (step 103), the contact information is rated based on the response from the phone call.

It is known in prior art how an autodialer can automatically distinguish the types of responses to a phone call. If the autodialer detects a busy signal, no answer or an answering machine (step 201), the autodialer marks the phone number to be tried again later. The number can be re-dialed a thresshold number of times (step 202), and if there is still no live answer, the contact can be rated as “not verified” (step 203). The thresshold number can be any arbitrary number.

If the autodialer detects an operator intercept (step 204) the contact information is marked as “invalid” (step 205). An operator intercept message typically states that the number is no longer in service.

Otherwise, the autodialer sends a pre-recorded message (step 206). In one embodiment, the pre-recorded message may ask the recipient of the phone call to press a key on their phone if they are interested in receiving information about a specified subject. If the autodialer detects that the key has been pressed, the contact is rated higher than if the autodialer does not detect the key being pressed.

In another embodiment, the pre-recorded message asks the recipient of the phone call to ansewer “yes” or “no” as to whether they are interested in receiving information about a specified subject. The autodialer then uses voice recognition to determine the recipient's response and rate the contact higher if the answer was “yes” and lower otherwise.

In one embodiment, the entire database of contacts or a subset of the database can be rated as a whole based on the ratings of the contacts in the database or subset, e.g. based on the average rating of the contacts in the database or subset.

1. A method for using and autodialer to automatically rate contact information entered on a website comprising the following steps:
A. Obtaining contact information electronically from a website.
B. Storing the contact information electronically in a database.
C. Using an autodialer to call the phone number in the database and detecting the type of response received from the phone call.
D. Rating the contact information based on the type of response received and storing the rating in the database.

2. A method for using and autodialer to automatically rate contact information as in claim 1 further comprising the step of sending a pre-recorded message if a live voice is detected and rating the contact information based on the response provided to the pre-recorded message.

3. A method for using and autodialer to automatically rate contact information as in claim 1 accumulating numbers into the database and calling the numbers at an appropriate time.

4. A method for using and autodialer to automatically rate contact information as in claim 1 further comprising the step assigning a rating to the entire database or a subset of the database based on the ratings of the contacts within the database or subset.
